(19) United States
(12) Patent Application Publication
(10) Pub. No.: US 2009/0016610 A1
(43) Pub. Date: Jan. 15, 2009

(54) Methods of Using Motion-Texture Analysis to Perform Activity Recognition and Detect Abnormal Patterns of Activities

(75) Inventors: Yunqian Ma, Roseville, MN (US); Isaac Cohen, Minneapolis, MN (US); Petr Cisar, Suchdol nad Luznici (CS)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/775,053

(22) Filed: Jul. 9, 2007

(51) Int. Cl. G06K 9/46

(52) U.S. Cl. 382/195

(57) ABSTRACT

Methods of using motion-texture analysis to perform video analytics are disclosed. One method includes selecting a plurality of frames from a video sequence, analyzing motion textures in the plurality of frames to identify a flow, extracting features from the flow, and characterizing the extracted features to perform activity recognition. Another method includes selecting a plurality of frames from a video sequence, analyzing motion textures in the plurality of frames to identify a flow, extracting first features from the flow, comparing the first features with second features extracted during a previous training phase, and based on the comparison, determining whether the first features indicate abnormal activity. Another method includes partitioning a given frame in a video sequence into a plurality of patches, forming a vector model for each patch by analyzing motion textures associated with that patch, and clustering patches having vector models that show a consistent pattern.

### FIELD OF THE INVENTION

The present invention relates to video surveillance, and, more particularly, to using motion-texture analysis to perform video analytics.

### BACKGROUND

The field of video surveillance has become increasingly important in the recent years following terrorist actions and threats. In particular, demand has increased for intelligent video surveillance, which involves high-level event detection (ergo, detection of the activity of people, such as people falling, loitering, etc.). Traditionally, high-level event detection is performed using low-level image-processing modules (e.g., motion-detection modules such as motion detection and object tracking). In such a motion-detection module, each pixel in an input image is separated and grouped into either a foreground region or a background region. Pixels grouped into the foreground region may represent a moving object in the input image. Typically, these foreground regions are tracked over time and analyzed to recognize activity.

However, there are problems associated with using these low-level image-processing modules. For instance, such a module can be ineffective when performing video analytics in a crowded area. As an example, in crowded scenes, people and other moving objects are more likely to be grouped into a single moving region. When a group of people are grouped into a single moving region, using video analytics to perform activity recognition of an individual within the single moving region may become more difficult.

### BRIEF DESCRIPTION OF THE DRAWINGS

Embodiments of the invention are described herein with reference to the drawings, in which:

FIG. 1 is a flow chart of a method, according to an example;

FIG. 2 includes screenshots of frames of a video sequence that are segmented into patches, according to an example;

FIG. 3 includes depicts screenshots of a frame and a corresponding vector-model map, according to an example;

FIG. 4 is an illustration of a 3×3 positional patch array, a 3×3 distance patch array, and a 3×3 vector-model patch may, according to an example;

FIG. 5 is an illustration of a 3×3 vector-model map, according to an example;

FIG. 6 is a vector-model map that includes a center and a sequence of vector models, according to an example;

FIG. 7 is a screenshot of a frame of a video sequence, according to an example;

FIG. 8 is a flow chart of a method, according to an example;

FIGS. 9A, 9B, 9C, 9D, 9E, and 9F include screenshots of a variety of frames, according to examples;

FIG. 10 includes a plurality of simplified intensity-value bar graphs, according to examples;

FIG. 11 includes screenshots of a variety of frames, according to examples;

FIG. 12 is a screenshot of a frame including a predetermined vector, according to an example;

FIG. 13 is a screenshot of a frame including a predetermined vector pointing to the left and a predetermined vector pointing to the right, according to an example;

FIG. 14 is a block diagram of a dynamic Bayesian network, according to an example.

FIG. 15 depicts a first and second tables that each include a respective set of numerical values; and

FIG. 16 is a flow chart of a method, according to an example.

### DETAILED DESCRIPTION

### I. Overview

Methods of using motion-texture analysis to perform video analytics are disclosed. According to an example, a method may include segmenting regions in a video sequence that display consistent patterns of activities. According to the method, the method includes partitioning a given frame in a video sequence into a plurality of patches, forming a vector model for each patch by analyzing motion textures associated with that patch, and clustering patches having vector models that show a consistent pattern. Clustering patches (i.e., segmenting a region in the frame) that show a consistent pattern may individually segment an object that is moving as a single block with other objects. Hence, for a group of objects moving as a single block, each object may be individually distinguished.

According to another example, a method may include using motion textures to recognize activities of interest in a video sequences. According to the method, the method includes selecting a plurality of frames from a video sequence, analyzing motion textures in the plurality of frames to identify a flow, extracting features from the flow, and characterizing the extracted features to perform activity recognition. Performing activity recognition may assist a user to identify the movement of a particular object in a crowded or sparse scene, or isolate a particular type of motion of interest (e.g., loitering, falling, running, walking in a particular direction, standing, and sitting) in a crowded or sparse scene, as examples.

According to another example, a method may include using motion textures to detect abnormal activity. According to the method, the method includes selecting a first plurality of frames from a first video sequence, analyzing motion textures in the first plurality of frames to identify a first flow, extracting first features from the first flow, comparing the first features with second features extracted during a previous training phase, and based on the comparison, determining whether the first features indicate abnormal activity. Determining whether the first features indicate abnormal activity may alert a user that an object is moving in an unauthorized direction (e.g., entering an unauthorized area), for example.

These as well as other aspects and advantages will become apparent to those of ordinary skill in the art by reading the following sections, with appropriate reference to the accompanying drawings.

### II. Methodology I

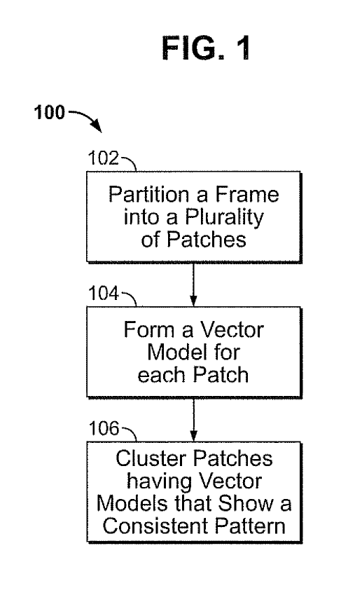

FIG. 1 is a flow chart of a method 100, according to an example. Two or more of the functions shown in FIG. 1 may occur substantially simultaneously.

The method 100 may include segmenting regions in a video sequence that display consistent patterns of activities. As depicted in FIG. 1, at block 102, the method includes partitioning a given frame in a video sequence into a plurality of patches. At block 104, the method includes forming a vector model for each patch by analyzing motion textures associated with that patch. At block 106, the method includes clustering patches having vector models that show a consistent pattern.

At block 102, the method includes partitioning a given frame in a video sequence into a plurality of patches. The given frame may be part of a plurality of frames in the video sequence. For instance, T frames of the video sequence may be selected from a sliding window of time (e.g., t+1, . . . , t+T). A given frame in the video sequence may include one or more objects, such as a person or any other type of object that may move, or be moved, over the course of the time period set by the sliding window. Further, the given frame includes a plurality of pixels, with each pixel defining a respective pixel position and intensity value.

Partitioning a given frame into a plurality of patches may include spatially partitioning the frame into n patches. Each patch in the plurality of patches is adjacent to neighboring patches. Further, each of the patches may overlap with one another.

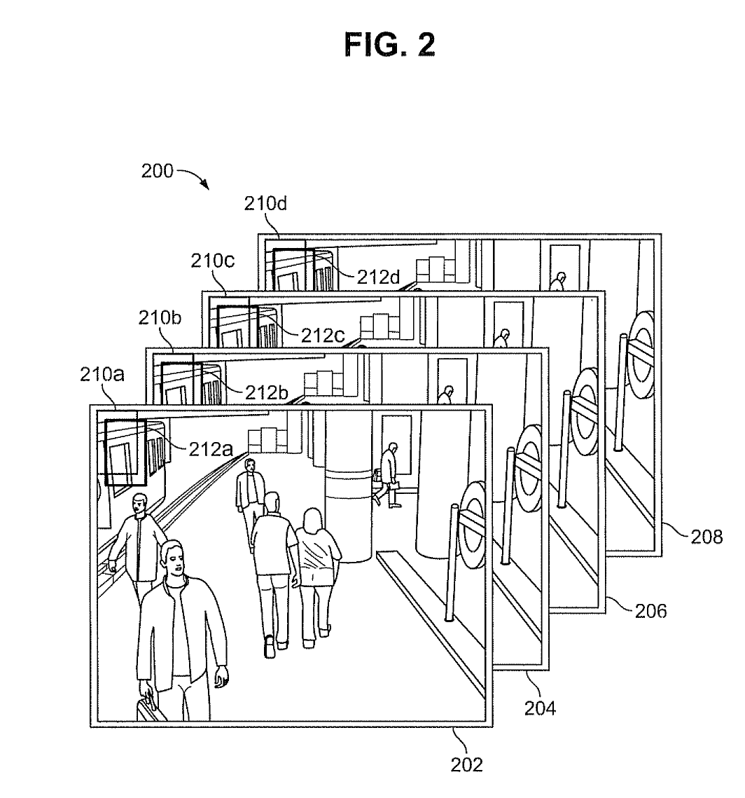

FIG. 2 includes screenshots 200 of frames 202, 204, 206, and 208 of a video sequence that are segmented into patches, according to an example. As shown, each of the frames 202, 204, 206, and 208 is partitioned into a first patch 210a, 210b, c, and 210d, respectively, and a second patch 212a, 212b, 212c, and 212d, respectively. Although only two patches are depicted for each frame, a given frame may be partitioned into a greater number of patches, and the entire frame is preferably partitioned into patches. As depicted in FIG. 2, the first patch 210a and second patch 212a, for example, partially overlap with one another. Alternatively, the patches may not overlap with one another.

Additionally, the patches may take any of a variety of shapes, such as squares, rectangles, or pentagons. Further, each patch includes a corresponding group of pixels. Also, the pixel size of the patches may vary. For instance, the patch size may range from a 5×5 pixel dimension to a 40×40 pixel dimension. As a given object may intersect with a plurality of patches, the pixel size of each patch may be the spatial resolution of the segmentation of each object.

At block 104, the method includes forming a vector model for each patch by analyzing motion textures associated with that patch. The vector model for each patch may be formed in any of a variety of ways. For instance, forming the vector model may include (i) estimating motion-texture parameters for each patch in the plurality of patches, (ii) for each given patch in the plurality of patches and for each neighboring patch to the given patch, calculating a motion-texture distance between the motion-texture parameters of the given patch and the motion-texture parameters of the neighboring patch, and (iii) based on the motion-texture-distance calculations for each patch in the plurality of patches, forming a vector model for each patch in the plurality of patches.

Estimating motion-texture parameters for each patch in the plurality of patches may be done using any of a variety of techniques, such as the Soatto suboptimal method of matrices estimation. Further details regarding Soatto's suboptimal method of matrices estimation are provided in S. Soatto, G. Doretto, and Y. N. Wu, “Dynamic Textures,” International Journal of Computer Vision, 51, No. 2, 2003, pp. 91-109 (“Soatto”), which is hereby incorporated by reference in its entirety.

In one embodiment, before estimating motion-texture parameters, each of the patches of the frame may be reshaped. This may include reshaping each patch into a multi-dimensional array (Y) that includes dimensions xₚ (e.g., a horizontal axis), yₚ (e.g., a vertical axis), and T (e.g., a time dimension). After each patch is reshaped in such a way, the motion-texture parameters for each patch may then be estimated. However, motion-texture parameters for each patch may be estimated without reshaping each patch as well.

To estimate motion-texture parameters for each patch, motion textures may first be mathematically approximated. For instance, motion textures may be associated with an auto-regressive, moving average process of a second order with an unknown input. As an example, the following equations may cooperatively represent a motion texture:

$$\{ \begin{matrix}x ( t + 1 ) = Ax ( t ) + v ( t ) & x ( 0 ) = {x}_{0} ; v ( t ) ∼ N ( 0 , Q ) \\ y ( t ) = Cx ( t ) + w ( t ) & w ( t ) ∼ N ( 0 , R )\end{matrix}$$

In the above equations, y(t) represents the observation vector. The observation vector y(t) may correspond to a respective intensity value for each pixel, the intensity value ranging from 0 to 255, for instance. Additionally, x(t) represents a hidden state vector. As opposed to the observation vector, y(t), the hidden state vector is not observable. Further, A represents the system matrix, and C represents the output Matrix. Additionally, v(t) represents the driving input to the system, such as Gaussian white noise, and w(t) represents the noise associated with observing the intensity of each pixel, such as the noise of the digital picture intensity, for instance. Further details regarding the variables of the auto-regressive, moving average process equations can be found in Soatto.

Once the respective motion texture for each of the patches is mathematically approximated, the motion-texture parameters for each patch may then be estimated. For example, the motion-texture parameters may be represented by the matrices A, C, Q (the driving input covariance matrix, which represents the standard deviation of the driving input, v(t)), and R (the covariance matrix of the measurement noise, which represents the standard deviation of the Gaussian noise, w(t)). To obtain estimations for the matrices A, C, Q, and R, the Soatto suboptimal method of matrices estimation may be used. In such a method of matrices estimation, let m>>n, rank(C)=n, and C^{T}C=Iₙ, so as to identify a unique model from a sample path y(t), where Iₙ is the identity matrix. The suboptimal method of matrices estimation is shown as follows:

(1) First, perform singular value decomposition on Y, such that:

Y=UΣV_{T}

(2) Then, estimate matrix C as:

Ĉ(τ)=U

(3) Next, the sequence of states X is estimated as \hat{X}=ΣV^{T}
(4) Then, the matrix A is estimated as:

$$\hat{A} = {ΣV}^{T} [ \begin{matrix}0 & 0 \\ {I}_{r - 1} & 0\end{matrix} ] {V ( {V}^{T} [ \begin{matrix}{I}_{r - 1} & 0 \\ 0 & 0\end{matrix} ] V )}^{- 1} {Σ}^{- 1} ,$$

where Iᵣ₋₁ is the identity matrix of the dimension (r−1)×(r−1)
(5) Next, estimate the driving input as:

v(k)=x(k)−Ax(k−1)

(6) Then, estimate the driving input covariance matrix Q as:

$$Q = \frac{1}{T - 1} {\sum }_{t = 1}^{T} v ( t ) {v}^{′} ( t )$$

(7) Finally, compute the covariance matrix of the measurement noise R as:

R=Y−C*X.

Hence, estimations may be obtained for the matrices A, C, Q, and R, and the estimations of these matrices may be used to cooperatively represent the respective motion-texture parameters for each of the patches.

Next, for each given patch in the plurality of patches and for each neighboring patch to the given patch, forming the vector model may include calculating a motion-texture distance between the motion-texture parameters of the given patch and the motion-texture parameters of the neighboring patch. Motion-texture distances for each patch may be determined in any of a variety of ways. For instance, calculating the motion-texture distances may include comparing the motion-texture parameters of the given patch with the motion-texture parameters of the neighboring patch.

As another example, calculating a motion-texture distance between the motion-texture parameters of the given patch and the motion-texture parameters of the neighboring patch may include determining a respective Mahalanobis distance between the motion-texture parameters of the given patch (i.e., the given patch's observation) and the motion-texture parameters of the neighboring patch (i.e., the respective observation of the neighboring patch). The Mahalanobis distance between the motion-texture parameters of a given patch and the motion-texture parameters of the neighboring patch may be calculated using the method disclosed in A. Chan and N. Vasconcelos, “Mixtures of Dynamic Textures,” Intl. Conf. on Computer Vision, 2005 (“Chan”), which is hereby incorporated by reference in its entirety. Using Chan's method, a calculation is made as to the probability that a measured sequence Y is generated by motion textures with particular notion-texture parameters. Specifically, this probability is computed as the Mahalaniobis distance of a measurement y(t) and an estimated ŷ(t) of a distribution Σ. The Mahaniaobis distance may be defined as MDC(ŷ,y)=\sqrt{(ŷ−y)^{T}Σ(ŷ−y)}, where Σ=C*E(t)*C′+R, and E(t) is the error covariance matrix computed by a Kalman filter.

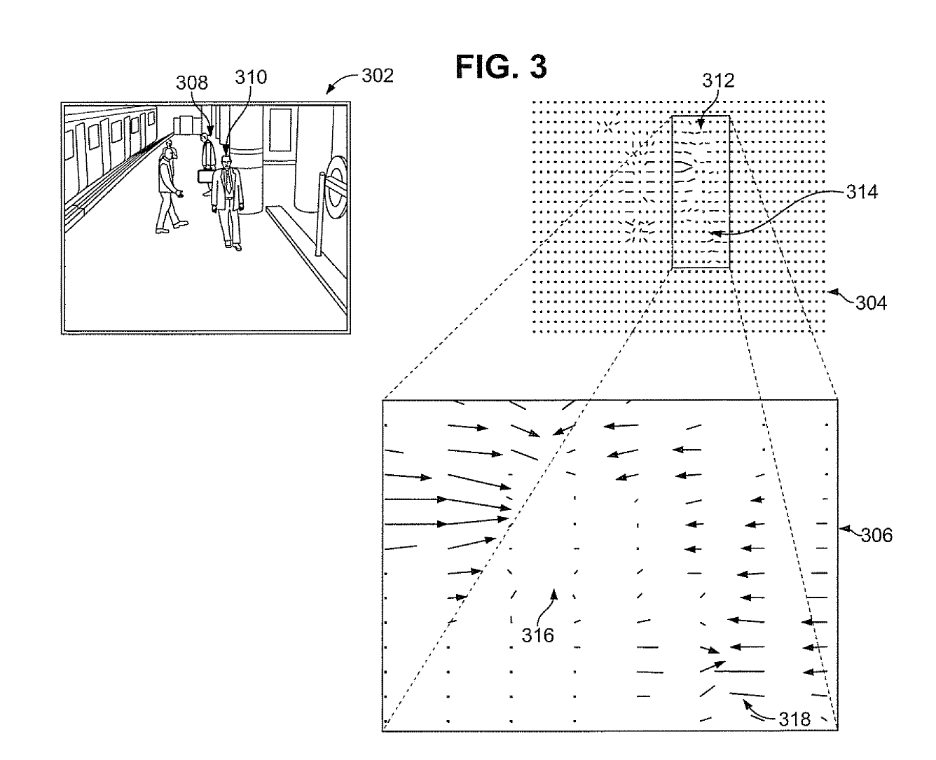

Next, forming a vector model for each patch may include forming a vector model for each patch based on the motion-texture distance calculations for each patch. Each patch may be represented by its respective vector model. For example, when an eight-neighborhood is used to form a vector model for a given patch, forming a vector model for the given patch may include selecting at least one neighboring patch. A selected neighboring patch may include motion-texture parameters that define the shortest motion-texture distance between the motion-texture parameters of the given patch and the motion-texture parameters of each of the neighboring patches. Further, the vector model may originate from approximately the center of the given patch and may generally point towards the one or more selected neighboring patches. Additionally, the vector model includes a magnitude that may represent the motion-texture distance between the motion-texture parameters of the given patch and the motion-texture parameters of the one or more selected neighboring patches. FIG. 3 depicts screenshots of a frame 302 and a corresponding vector-model map 304, according to an example. As depicted in FIG. 3, the frame 302 includes objects 308 and 310, and the vector-model map 304 includes vector model clusters 312 and 314 that correspond to the objects 308 and 310, respectively. View 306 provides an enlarged view of the vector model clusters 316 and 318, which correspond to the vector model clusters 312 and 314, respectively.

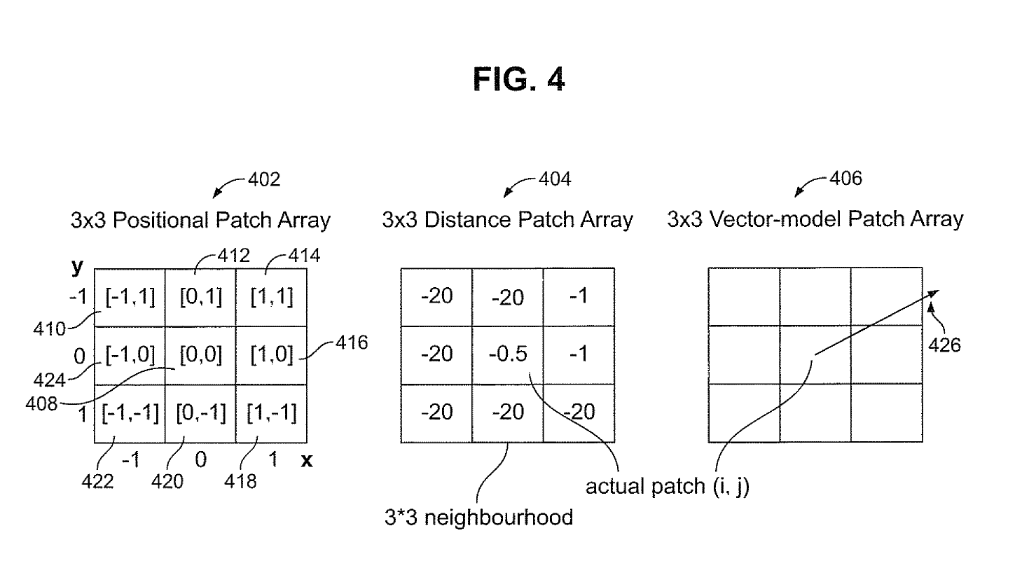

Further, FIG. 4 is an illustration of a 3×3 positional patch array 402, a 3×3 distance patch array 404, and a 3×3 vector-model patch array 406, according to examples. As shown in the 3×3 positional patch array 402, patch 408 is located at (0,0), and is selected along with the adjacent neighboring patches 410, 412, 414, 416, 418, 420, 422, and 424 (here, an eight-patch neighborhood is selected). As shown in the 3×3 distance patch array 404, motion-texture distances between patch 408 and each of its neighboring patches is calculated. For instance, after estimating motion-texture parameters for each of the patches, a respective Mahalanobis distance between patch 408 and each of the patches 410, 412, 414, 416, 418, 420, 422, and 424 is calculated. Next, as shown in the 3×3 vector-model patch array 406, a vector model 426 is formed for the patch 408. As an example, the vector model for the patch 408 (i.e., V(i,j)=[k,l]) may be computed as:

$$k ( i , j ) = {\sum }_{\begin{matrix}x = - 1 \; 1. \\ y = - 1 \; 1\end{matrix}}^{ } ( 1 / abs ( MDC ( i + x , j + y ) ) * x \\ l ( i , j ) = {\sum }_{\begin{matrix}x = - 1 \; 1. \\ y = - 1 \; 1\end{matrix}}^{ } ( 1 / abs ( MDC ( i + x , j + y ) ) * y$$

where k is along the x-direction and l is along the y-direction. The magnitude, s, of the vector model, V, is given by s=\sqrt{k²+l²}, and the angle of the vector model, α, is given by

$$α = arc tan \frac{l}{k} .$$

The magnitude of the vector model may reflect the distance between actual patch 408 and its neighboring patches. Further, the vector model may point towards the patch that is most similar to the actual patch 408. As a result of this calculation, the vector model for the patch 408 may be formed.

Next, at block 106, the method includes clustering patches having vector models that show a consistent pattern A consistent pattern of vector models may be shown in any of a variety of ways. For example, vector models that show a consistent pattern may include vector models that are concentric around a given patch. To illustrate, the vector models for each patch in a frame may cooperatively define a vector-model map, and the vector-model map may include a center. The patches that have vector models that generally point toward the center may be clustered.

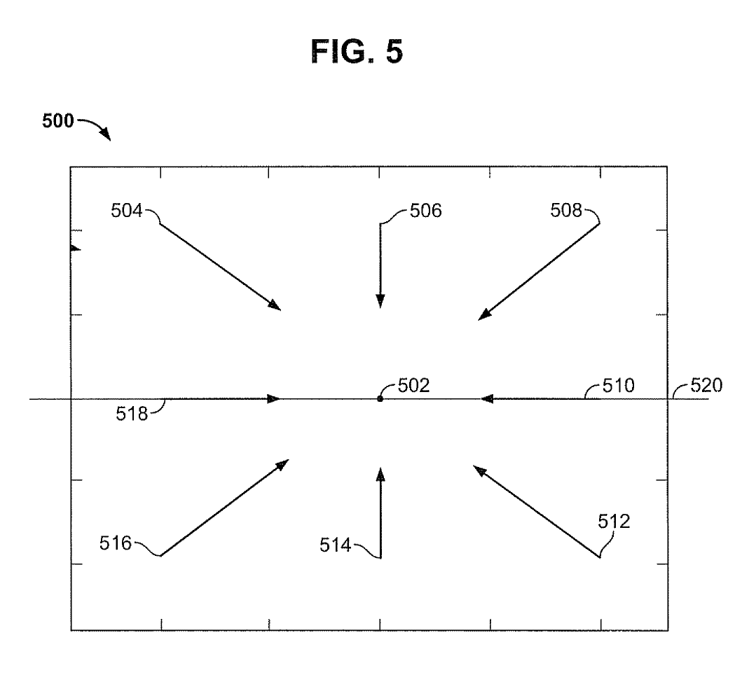

A center in the vector-model map may be defined as a patch that has a threshold number of neighboring patches that each have vector models that are angled toward the patch. As an example of determining a center in a vector-model map, FIG. 5 is an illustration of a 3×3 vector-model map 500, according to an example, As depicted, the 3×3 vector-model map 500 includes a vector model for patch 502, and vector models 504, 506, 508, 510, 512, 514, 516, and 518. Each of the vector models 504, 506, 508, 510, 512, 514, 516, and 518 represents a corresponding neighboring patch. As depicted in FIG. 5, the vector model for the patch 502 is approximately zero, and each of the vector models 504, 506, 508, 510, 512, 514, 516, and 518 are angled toward the patch 502. For instance, the vector model 504 is angled 315° away from the horizontal line 520 of patch 502, the vector model 506 is angled 270° away from the horizontal line 520, the vector model 508 is angled 225° away, the vector model 510 is angled 180° away, the vector model 512 is angled 135° away, the vector model 514 is angled 90° away, the vector model 516 is angled 45° away, and the vector model 516 is angled 0° away.

Each of the above angles corresponding to each of vector models 504, 506, 508, 510, 512, 514, 516, and 518 represent ideal angles that may be used to determine whether a given vector model is angled toward patch 502. In this ideal situation, patch 502 is a center because (i) all eight of the surrounding vector models are (ii) angled toward patch 502 (additionally, patch 502 may be a center because the vector model for patch 502 is approximately zero). However, patch 502 may still be determined to be a center even if all eight of the surrounding vector models are not angled toward patch 502. For instance, patch 502 may be determined to be a center so long as a threshold number of surrounding vector models are angled toward it. The threshold number of vector models may range from 4 to 8, for example.

Furthermore, a given surrounding vector model may be angled towards patch 502 even if the given vector model is not angled at its respective ideal angle Deviations from the ideal angles are possible. As an example, an allowable angle of deviation for a given vector model may range from −θ to θ (e.g., θ can be 15°). Further, the respective allowable angle of deviation for each surrounding vector model may vary from one another.

Once a center in the vector-model map is determined, the patches that have vector models that generally point toward the center are clustered. In other words, the region that includes patches that have vector models generally pointing toward the center is segmented. Of course, the vector-model map may contain more than one center, in which case each center will be associated with its own corresponding class of vector models that generally point toward it.

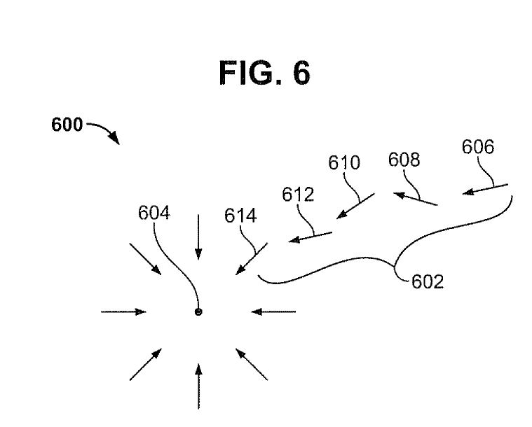

There are a variety of ways to determine the vector models that generally point toward a center. To illustrate an example, FIG. 6 is a vector-model map 600 that includes a center 604 and a sequence of vector models 602, according to an example. The sequence of vector models 602 includes vector models 606, 608, 610, 612, and 614. As shown, the vector-model 606 is angled towards vector model (or patch) 608, and the vector model 608 is angled towards vector model 610. As such, the vector models 606, 608, and 610 cooperatively define a linked list of vector models. Further, since the vector model 610 is angled towards vector model 612, and the vector model 612 is angled towards vector model 614, each of the vector models 610, 612, and 614 is also included in the linked list of vector models. Hence, the vector models 606, 608, 610, 612, and 614 cooperatively define the linked list of vector models.

Since vector model 614, the final vector model in the linked list of vector models, is pointed toward the center 604, the trajectory of the linked list of vector models is pointed toward the center 604. Since the trajectory of the linked list of vector models is pointed toward the center 604, each vector model in the linked list of vector models (i.e., the sequence of vector models 602) is grouped into a class corresponding to the center 604.

Additionally, just as each center preferably corresponds to its own class of vector models that generally point toward the respective center, each class of vector models preferably corresponds to an object in the frame of the video sequence. Hence, if a given frame includes a plurality of objects, clustering patches having vector models that show a consistent pattern may include clustering the patches into a plurality of clusters that each correspond to a given object.

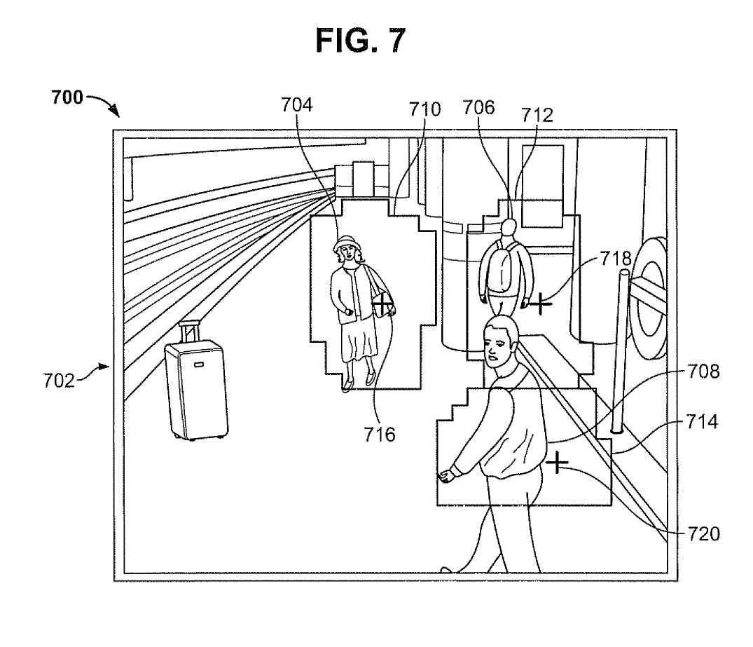

To illustrate, FIG. 7 is a screenshot 700 of a frame 702 of a video sequence, according to an example. As depicted in FIG. 7, the frame 702 includes objects 704, 706, and 708. Each of the objects 704, 706, and 708 is surrounded (at least partially) by class outlines 710, 712, and 714, respectively, and includes centers 716, 718, and 720, respectively. If depicted as a corresponding vector-model map, then the class outlines 710, 712, and 714 would preferably include vector models that generally point toward centers 716, 718, and 720, respectively. Hence, each of the centers 716, 718, and 720 corresponds to class outlines (i.e., classes of vector models) 710, 712, and 714, respectively, and each of the class outlines 710, 712, and 714 corresponds to objects 704, 706, and 708, respectively. The method 100 may then repeat to block 102 for the next frame of the video sequence, and for each other frame in the video sequence.

Next, a representation of the one or more clusters of patches may be displayed to a user, or used as input for activity recognition. The representation of the clusters of patches may take any of a variety of forms, such as a depiction of binary objects. Further, the clusters of patches may be displayed on any of a variety of output devices, such as a graphic-user-inter face display. Displaying a representation of the one or more clusters of patches may assist a user to perform activity recognition and/or segment objects that are moving together in a frame.

### III. Methodology II

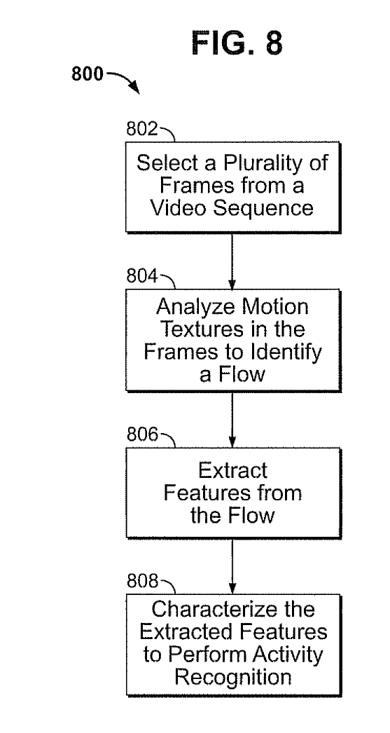

FIG. 8 is a flow chart of a method 800, according to an example. Two or more of the functions shown in FIG. 8 may occur substantially simultaneously.

The method 800 may include using motion textures to recognize activities of interest in a video sequences. As depicted in FIG. 8, at block 802, the method includes selecting a plurality of frames from a video sequence. At block 804, the method includes analyzing motion textures in the plurality of frames to identify a flow, Next, at block 806, the method includes extracting features from the flow. At block 808, the method includes characterizing the extracted features to perform activity recognition.

At block 802, the method includes selecting a plurality of frames from a video sequence. The plurality of frames may include a first frame corresponding to a first time, a second frame corresponding to a second time, and a third frame corresponding to a third frame. Further, the first frame may include an object, and the second and third frames may also include the object. Additional objects may also be present in one or more of the frames as well.

At block 804, the method includes analyzing motion textures in the plurality of frames to identify a flow. The flow may define a temporal and spatial segmentation of respective regions in the frames, and the regions may show a consistent pattern of motion. Further, analyzing motion textures in the plurality of frames may to identify a flow may include (i) partitioning each frame into a corresponding plurality of patches, (ii) for each frame, identifying a respective set of patches in the corresponding plurality of patches, wherein the respective set of patches correspond to the respective region in the frame, and (iii) identifying the flow that defines a temporal and spatial segmentation of the respective set of patches in each of the frames, wherein the respective set of patches for each of the frames show a consistent pattern of motion.

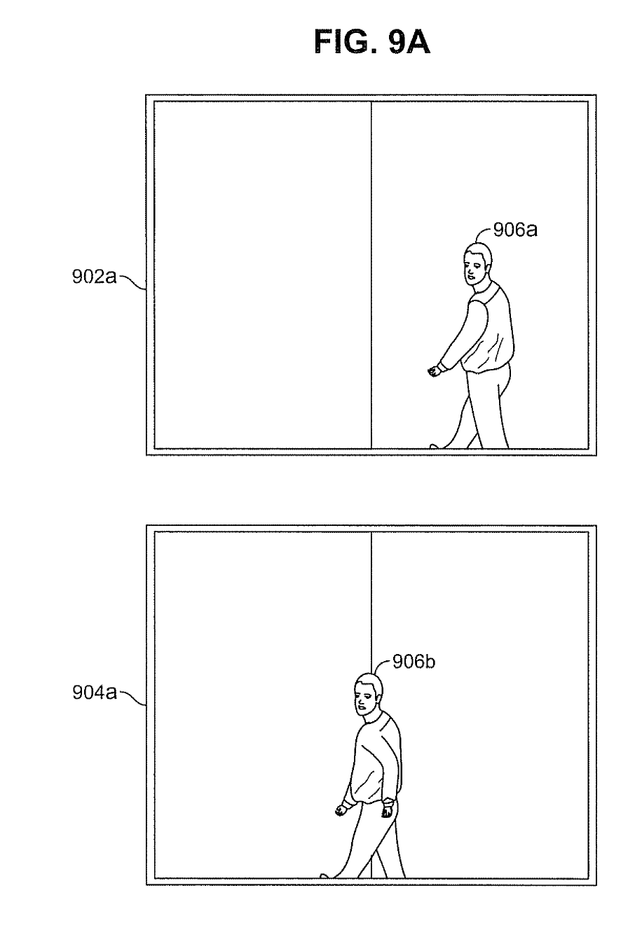

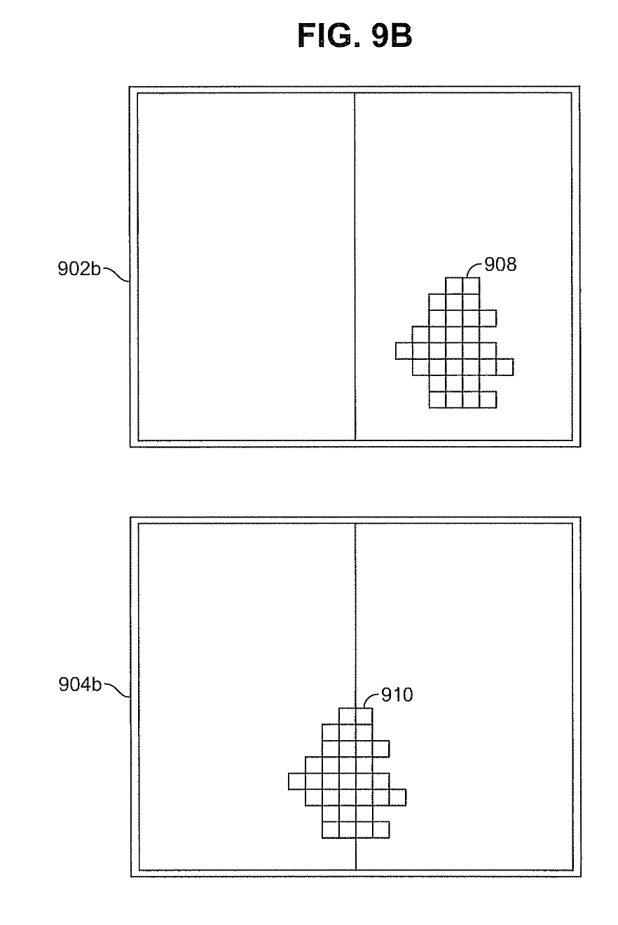

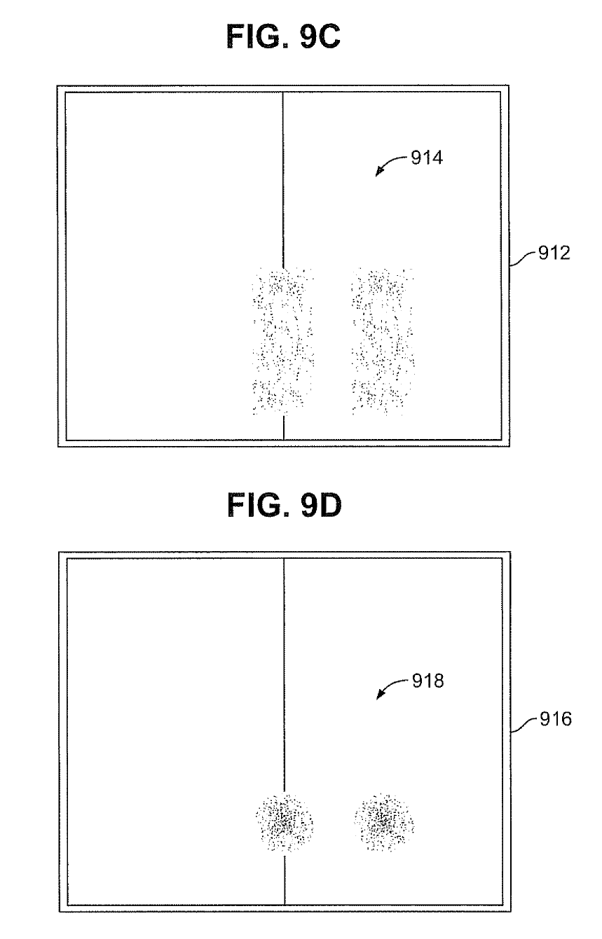

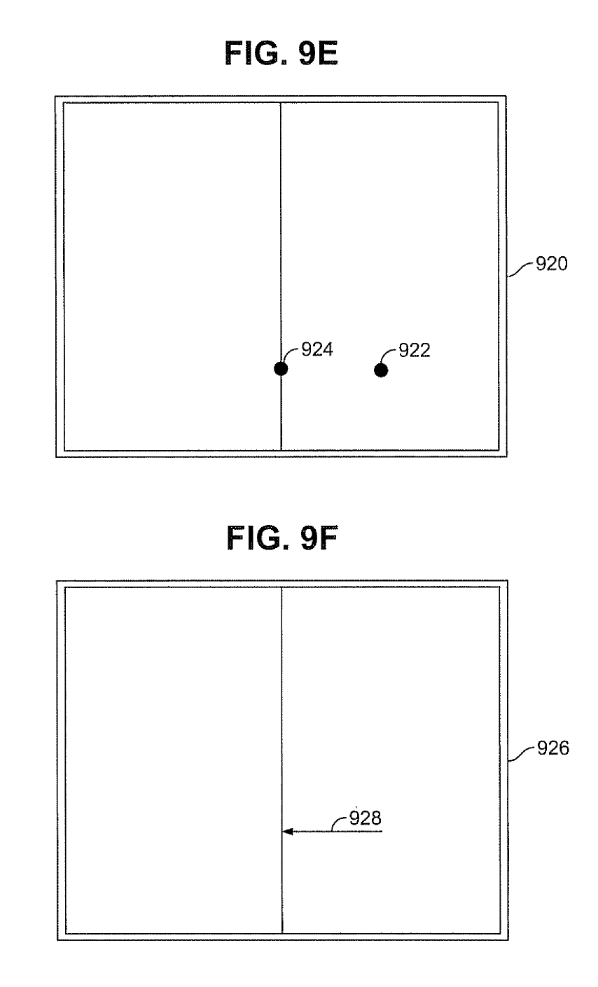

By way of example, FIG. 9A includes screenshots of frames 902a and 904a, and FIG. 9B includes screenshots of frames 902h and 904b, each according to examples. In FIG. 9A, frame 902a includes object 906a and frame 904a includes object 906b. In this example, the object 906a represents a person at a first time, and object 906b represents the same person at a second time. In FIG. 9B, frame 902h includes a first set of patches 908 corresponding to the object 906a, and frame 904b includes a second set of patches 910 corresponding to the object 906b. The first set of patches 908 in frame 902b at the first time and the second set of patches 910 in frame 904b at the second time may define the temporal and spatial segmentation of the sets of patches 908 and 910 in each of the frames 902b and 904b, respectively. The sets of patches 908 and 910 in each of the frames 902b and 904b, respectively, show a consistent pattern of motion (e.g., the object 906a moving to the left). Further, the first set of patches 908 may include a first set of pixels, with each pixel in the first set of pixels defining a respective pixel position and intensity value. Similarly, the second set of patches 910 may include a second set of pixels, with each pixel in the second set of pixels defining a respective pixel position and intensity value.

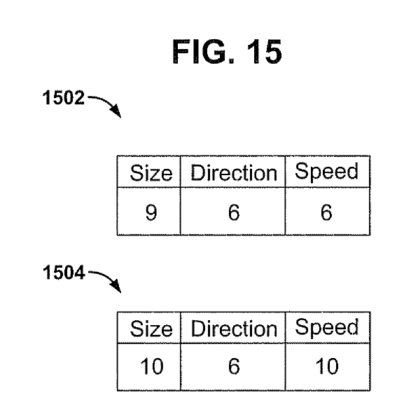

At block 806, the method includes extracting features from the flow. Extracting features from the flow may take any of a variety of configurations. As an example, extracting features from the flow may include producing parameters that describe a movement. An example of such parameters include a set of numerical values, with a first numerical value indicating an area of segmentation for an object in a frame, a second numerical value indicating a direction of movement, and a third numerical value indicating a speed. FIG. 15 depicts a table 1502 that includes the set of numerical values. Of course, other examples exist for parameters describing a movement.

As another example, extracting features from the flow may include forming a movement vector (a movement vector may be an example of a more general motion-texture model). A movement vector may be formed in any of a variety of ways. By way of example, forming the first movement vector may include subtracting the intensity value of each pixel in frame 902b from the intensity value of a corresponding pixel in frame 904b to create an intensity-difference gradient. The intensity-difference gradient may include respective intensity-value differences between (1) each pixel in the first set of pixels and a corresponding pixel in frame 904b, and (2) each pixel in the second set of pixels and a corresponding pixel in frame 902b. The intensity-value differences between (1) each pixel in the first set of pixels and a corresponding pixel in frame 904b cooperatively correspond to the object 906a in the frame 902a, and the intensity-value differences between (2) each pixel in the second set of pixels and a corresponding pixel in frame 902b cooperatively correspond to the object 906b in the frame 904a. FIG. 9C is a screenshot of frame 912 including an intensity-difference gradient 914, according to an example.

The intensity-value differences, diff(t), may be computed where y(t) is t^{th} frame of the patch and T is number of frames of the patch. For example, diff (t) may be computed as:

diff(t)=|y(t)−y(t−1)|, t=1, . . . , T−1

As depicted in the above equation, subtracting the intensity values may include taking the absolute value of the difference between the intensity value of each pixel in frame 902b and the intensity of the corresponding pixel in frame 904b.

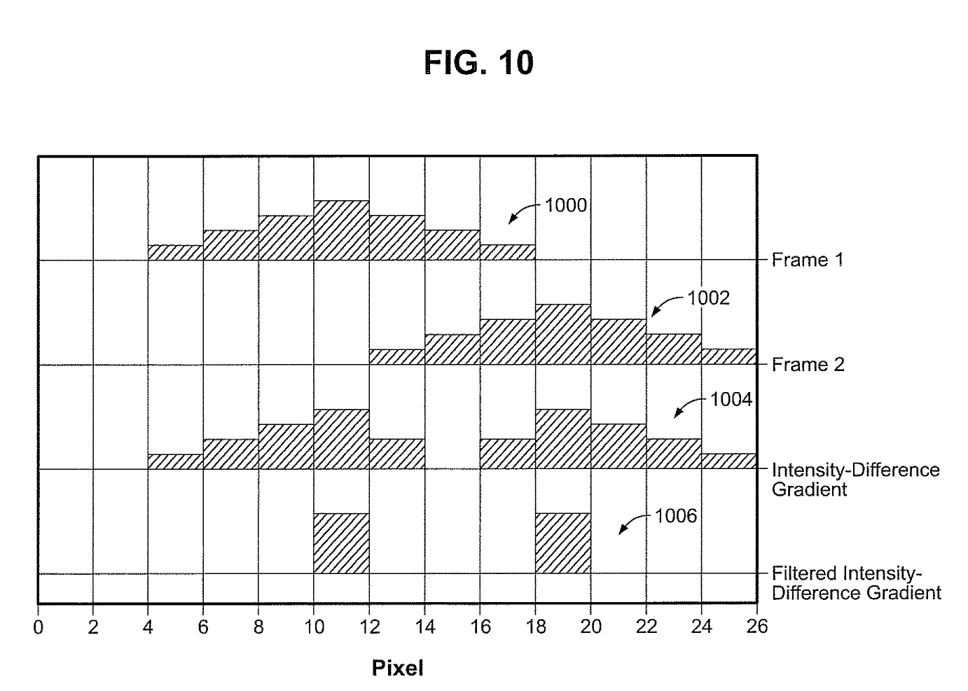

To further illustrate, FIG. 10 includes a simplified intensity-value bar graph 1000 corresponding to the frame 902b, and a simplified intensity-value bar graph 1002 corresponding to the frame 904b, according to examples. Further, FIG. 10 includes a simplified intensity-value bar graph 1004 corresponding to the intensity-difference gradient 914, according to an example.

Forming the first movement vector for the object may further include filtering the intensity-difference gradient by zeroing the respective intensity-value differences that are below a threshold, Zeroing the respective intensity-value differences that are below a threshold may highlight the pixel positions corresponding to the significant intensity-value differences. The pixel positions corresponding to the significant intensity-value differences may correspond to important points of the object, such as the object's silhouette. Further, zeroing the respective intensity-value differences that are below a threshold may also allow just the significant intensity-value differences to be used to form the first movement vector. FIG. 9D is a screenshot of a frame 916 including a filtered intensity-difference gradient 918, according to an example.

The threshold may be computed in any of a variety of ways. For instance, the intensity values corresponding to the first and second set of pixels may include a maximum-intensity value (e.g., 200), and the threshold may equal 90%, or any other percentage, of the maximum-intensity value (e.g., 180). Hence, the intensity-value differences below 180 will be zeroed, and only the intensity-values at or above 180 will remain after the filtering step. To further illustrate. FIG. 10 includes a simplified intensity-value bar graph 1008 corresponding to the filtered intensity-difference gradient 918, according to an example. Of course, other examples exist for computing the threshold.

Forming the first movement vector may further include, based on the remaining intensity-value differences in the filtered intensity-difference gradient 918, determining a first average-pixel position corresponding to object 906a in frame 902a and a second average-pixel position corresponding to object 906b in frame 904a. FIG. 9E is a screenshot of a frame 920 that includes a first average-pixel position 922 corresponding to object 906a and a second average-pixel position 924 corresponding to object 906b, according to an examples.

Next, forming the first movement vector may include forming the first movement vector such that the first movement vector originates from the first average-pixel position (which may correspond to a first patch) and ends at the second average-pixel position (which may correspond to a second patch). FIG. 9F is a screenshot of frame 926 including the first movement vector 928, according to an example. As shown, the first movement vector 928 originates from the first average-pixel position 922 and ends at the second average-pixel position 924.

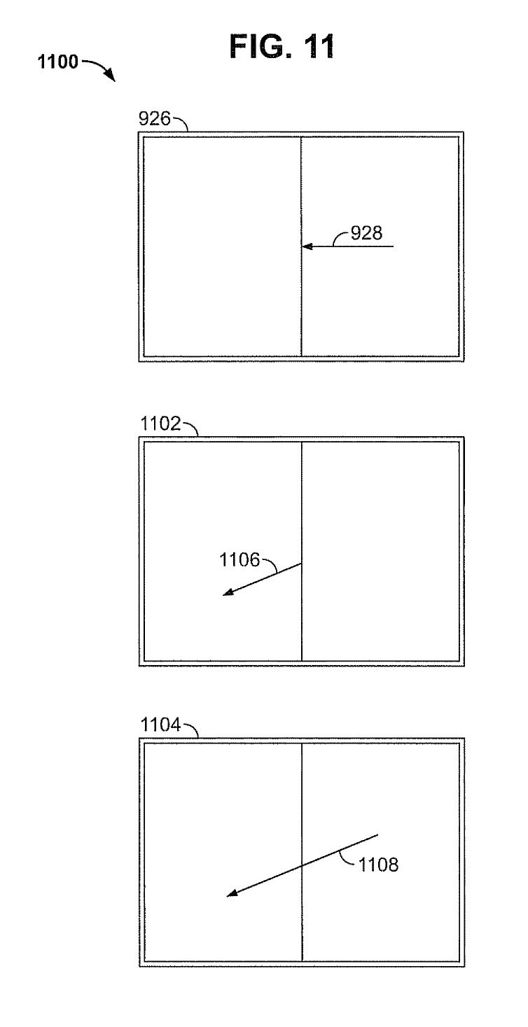

As yet another example, extracting features from the flow may include forming a plurality of movement vectors. Each movement vector may correspond to a predetermined number of frames. As an example, in a plurality of frames including a first frame (frame 902a), second frame (frame 904a), and third frame (not depicted), a first movement vector that corresponds to the first and second frames may be formed, and a second movement vector that corresponds to the second and third frames may be formed. To illustrate, FIG. 11 includes screenshots 1100 of frames 926, 1102, and 1104, according to examples Frame 926 includes the first movement vector 928 corresponding to the movement of object 906a from frame 902a to frame 904a, and frame 1102 includes a second movement vector 1106 corresponding to the movement of the object 906b from frame 904a to the third frame.

Of course, a given movement vector in the plurality of movement vectors may correspond to more than two frames. As an example, a given movement vector may correspond to three frames. By way of example, the given movement vector may be formed by summing the first and second movement vectors. As shown in FIG. 11, frame 1104 includes the given movement vector 1108, which is formed by summing the first movement vector 928 and the second movement vector 1106. Of course, other examples exist for forming the given movement vector. Further, other examples exist for extracting features from the flow.

At block 808, the method includes characterizing the extracted features to perform activity recognition. Characterizing the extracted features to perform activity recognition may take any of a variety of configurations. For instance, when the extracted features from the flow include parameters that describe a movement, characterizing the extracted features may include determining whether the parameters describing the movement are within a threshold to a predetermined motion model. By way of example, the parameters describing the movement may include the set of numerical values depicted in table 1502, and the predetermined motion model may include a predetermined set of numerical values, which, by way of example, is depicted in table 1504 of FIG. 15. In this case, determining whether the parameters are within a threshold to the predetermined motion model may include comparing each of the numerical values in table 1502 to a respective numerical value in the table 1504. Of course, other examples exist for determining whether the parameters describing the movement are within a threshold to a predetermined motion model.

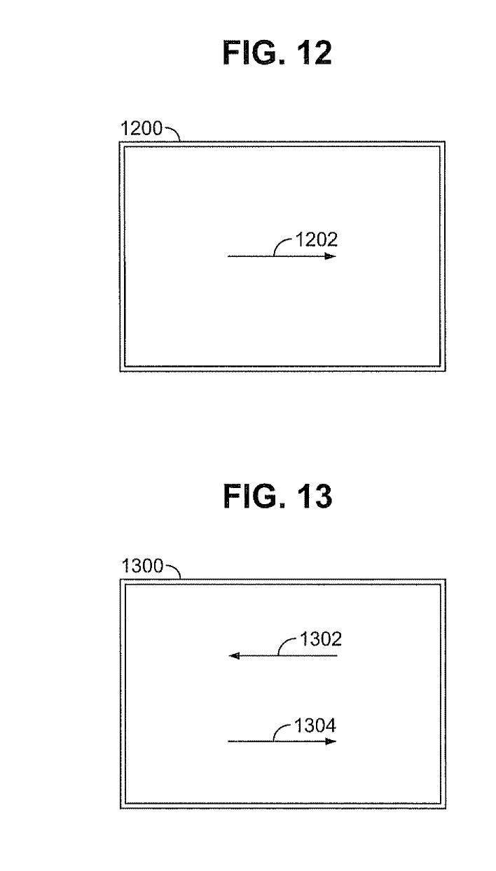

As another example, when the extracted features from the flow include a movement vector (or a plurality of movement vectors), characterizing the extracted features may include estimating characteristics (e.g. amplitude and/or orientation) of the movement vector(s). Characterizing the extracted features may further include comparing the characteristics of the movement vector(s) to the characteristics of at least one predetermined vector. FIG. 12 is a screenshot of a frame 1200 including a predetermined vector 1202 pointing to the right, according to an example. Comparing the magnitude and direction of the movement vector(s) to the magnitude and direction of the predetermined vector 1202 may include determining whether each of the magnitude and direction of the respective movement vectors is within a respective threshold to the magnitude and direction of the predetermined vector 1202. Based on the comparison, a user may determine whether an object in a video sequence is moving in a predetermined direction at a predetermined speed, for example. Of course, the characteristics of the movement vector may be compared to more than predetermined vector. To illustrate, FIG. 13 is a screenshot of a frame 1300 including a predetermined vector 1302 pointing to the left and a predetermined vector 1304 pointing to the right, according to an example.

As yet another example, the movement vector may traverse a patch (e.g., a patch corresponding to the first-average pixel position, second-average pixel position, or any other patch the movement vector may traverse), and characterizing the extracted features may include determining whether the movement vector is similar to a motion pattern defined by the patch.

As still yet another example, characterizing the extracted features to perform activity recognition may include performing simple-activity recognition. Simple-activity recognition may be used to determine whether each person in a crowd of people is moving in predetermined direction (or not moving), for example During simple-activity recognition, a predetermined motion model may be formed (e.g. during a training phase). The predetermined motion model may be formed in a any of a variety of ways. For example, the predetermined motion model may be selected from a remote or local database containing a plurality of predetermined motion models. As another example, the predetermined motion models may be formed by analyzing sample video sequences

The predetermined motion model may take any of a variety of configurations. For instance, the predetermined motion model may include a predetermined intensity threshold. As another example, the predetermined motion model may include one or more predetermined vectors. The one or more predetermined vectors may be selected from a database, or formed using a sample video sequence that includes one or more objects moving in one or more directions, as examples. Further, the predetermined vector may include a single predetermined vector (e.g., predetermined vector 1202 pointing to the right), or two predetermined vectors (e.g., predetermined vectors 1302 and 1304). Of course, additional predetermined vectors may also be used.

When analyzing a video sequence of an entryway into a secured area (e.g., during a testing phase), for example, every object whose respective movement vector is not in the general direction of the predetermined vector(s) (e.g., not in the exact direction as a predetermined vector, and also not within a certain angle of variance of the predetermined vector, such as plus or minus 15°) will be flagged as abnormal. Additionally or alternatively, every object in the video sequence that has an intensity threshold outside of a certain range of the predetermined intensity threshold may also be flagged as abnormal.

As another example, characterizing the extracted features to perform activity recognition may include performing complex-activity recognition. Performing complex-activity detection may include determining whether a predetermined number of simple activities have been detected. Further, determining whether a predetermined number of simple activities have been detected may include using a graphical model (e.g., a dynamic Bayesian network and/or a Hidden Markov Model).

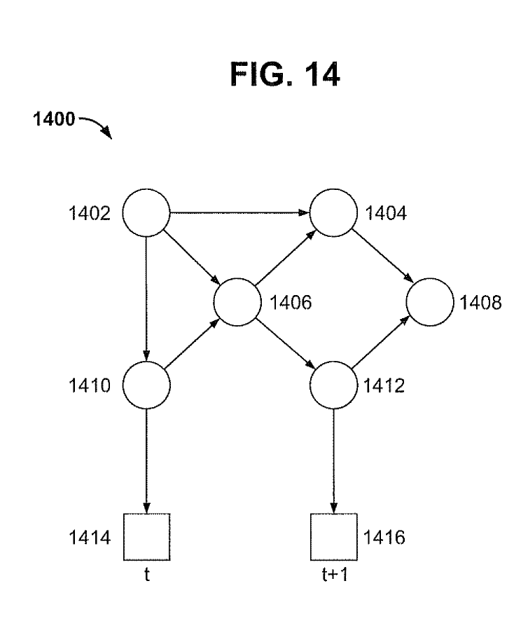

To illustrate, FIG. 14 is a block diagram of a dynamic Bayesian network 1400, according to an example. As depicted, the dynamic Bayesian network 1400 includes observation nodes (features) 1414 and 1416 at time t and time t+1, respectively, simple-activity nodes 1410 and 1412, complex-activity detection nodes 1402 and 1404, and finishing nodes 1406 and 1408. Finishing nodes 1406 and 1408 relate to observation nodes 1414 and 1416, respectively Although depicted as a two-layered dynamic Bayesian network, the dynamic Bayesian network 1400 may include a plurality of layers.

As noted, performing complex-activity detection may include determining whether a predetermined number of simple activities have been detected. By way of example, for three frames, an object's first movement vector may point to the right, and the first movement vector may count as one simple activity for the object. In the next three frames, the object's second movement vector may point to the left, and this may count as a second simple activity for the objects. In the next three frames, the object's third movement vector may point upwards, and the third movement vector may count as a third simple activity for the object. When three simple activities are detected for the object (the three simple activities may be unique to one another, or may repeat), the complex-activity detection node may be triggered. In the dynamic Bayesian network 1400, if the transition from the observation node 1414 to the observation node 1416 includes a third simple activity for the object, finish node 1406 may become a logic “1,” thus indicating a complex activity has been detected. On the other hand, if three simple activities for the object have not been detected during the transition from observation node 1414 to the observation node 1416, then the finish node may remain as a logic “0,” thus indicating that a complex activity has not been detected. Of course, other examples exist for detecting complex activity Performing activity recognition may assist a user to identify the movement of a particular object in a crowded scene, for instance.

### IV. Methodology III

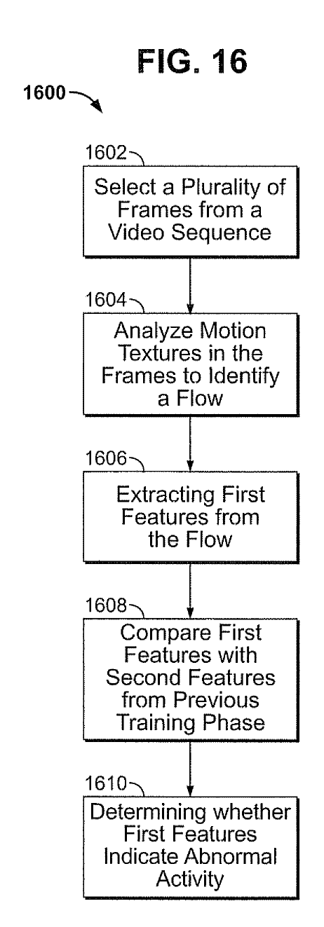

FIG. 16 is a flow chart of a method 1600, according to an example Two or more of the functions shown in FIG. 16 may occur substantially simultaneously, or may occur in a different order than shown.

The method 1600 may include using motion textures to detect abnormal activity. As depicted in FIG. 16, the method starts at block 1602, where a testing phase begins. At block 1602, the method includes selecting a first plurality of frames from a first video sequence. At block 1604, the method includes analyzing motion textures in the first plurality of frames to identify a first flow. Next, at block 1606, the method includes extracting first features from the first flow. At block 1608, the method includes comparing the first features with second features extracted during a previous training phase. At block 1610, based on the comparison, the method includes determining whether the first features indicate abnormal activity.

At block 1602, the method includes selecting a first plurality of frames from a first video sequence, Selecting a first plurality of frames from a first video sequence may be substantially similar to selecting a plurality of frames from a video sequence from block 802.

At block 1604, the method includes analyzing motion textures in the first plurality of frames to identify a first flow, Likewise, this step may be substantially similar to analyzing motion textures in the plurality of frames to identify a flow from block 804.

At block 1606, the method includes extracting first features from the first flow. Again, this step may be substantially to extracting features from the flow from block 806.

At block 1608, the method includes comparing the first features with second features extracted during a previous training phase. The training phase may take any of a variety of configurations. For instance, the training phase may include selecting second features from a plurality of predetermined features stored in a local or remote database. As another example, the training phase may include (i) selecting a second plurality of frames from a sample video sequence, (ii) analyzing motion textures in the second plurality of frames to identify a second flow, wherein the second flow defines a second temporal and second spatial segmentation of respective regions in the second plurality of frames, and wherein the regions show a second consistent pattern of motion, and (iii) extracting second features from the second flow. Of course, other examples exist for the training phase.

Further, comparing the first features with the second features may take any of a variety of configurations. For instance, the first and second features may include first and second motion-texture models, and the first and second motion-texture models may be compared. By way of example, the first and second motion-texture models may include first and second movement vectors, respectively, and the magnitude and/or direction of the first and second movement vectors may be compared. As another example, the first and second features may include first and second parameters that describe a movement (e.g., a first and second set of numerical values), respectively, the first and second parameters may be compared. Of course, other examples exist for comparing the first features with the second features.

At block 1610, based on the comparison, the method includes determining whether the first features indicate abnormal activity. Determining whether the first features indicate abnormal activity may include determining if a similarity measure between the first and second features exceeds a predetermined threshold. For instance, if the first and second features include first and second motion-texture models, abnormal activity may be determined if a similarity measure between the first and second motion-texture models exceeds a predetermined threshold. By way of example, if the first and second motion-texture models include first and second movement vectors, a similarity measure between the first and second vectors may include a measure between the respective magnitude and/or direction of the first and second movement vectors. If the difference between the magnitude and/or direction of the first and second movement vectors exceeds a predetermined threshold, then the object may be flagged as abnormal.

To illustrate, the predetermined threshold (e.g., an allowable departure from a learned motion model) may include a predetermined threshold for a feature (e.g., an angle of 25° for a movement vector). If a difference between the respective directions of the first and second movement vectors is within the predetermined threshold (e.g., 25° or less), then the first features will not indicate abnormal activity (i.e., the object characterized by the first features will not be flagged as abnormal). On the other hand, if the difference between the respective directions of the first and second movement vectors is greater than the predetermined threshold (e.g., greater than 25°), then the first features will indicate abnormal activity (i.e., the object characterized by the first features will be flagged as abnormal). Determining whether the first features indicate abnormal activity may help a user determine whether an object is entering an unauthorized area, for example.

### V. Conclusion

Exemplary embodiments of the present invention have been described above. Those skilled in the art will understand, however, that changes and modifications may be made to the embodiments described without departing from the true scope and spirit of the present invention, which is defined by the claims.

We claim:

1. A method of using motion textures to recognize activities of interest in a video sequence, the method comprising:
selecting a plurality of frames from the video sequence;
analyzing motion textures in the plurality of frames to identify a flow, wherein the flow defines a temporal and spatial segmentation of respective regions in the frames, and wherein the regions show a consistent pattern of motion;
extracting features from the flow; and
characterizing the extracted features to perform activity recognition.

2. The method of claim 1, wherein analyzing motion textures in the plurality of frames to identify a flow comprises;
partitioning each frame into a corresponding plurality of patches;
for each frame, identifying a respective set of patches in the corresponding plurality of patches, wherein the respective set of patches corresponds to the respective region in the frame; and
identifying the flow that defines a temporal and spatial segmentation of the respective set of patches in each of the frames, wherein the respective set of patches for each of the frames shows a consistent pattern of motion.

3. The method of claim 1, wherein extracting features from the flow comprises forming a movement vector, and wherein characterizing the extracted features to perform activity recognition comprises estimating characteristics of the movement vector.

4. The method of claim 3, wherein the movement vector traverses a patch, and wherein characterizing the extracted features to perform activity recognition further comprises determining whether the movement vector is similar to a motion pattern defined by the patch.

5. The method of claim 1, wherein extracting features from the flow comprises forming a plurality of movement vectors, wherein each movement vector corresponds to a predetermined number of frames, and wherein characterizing the extracted features to perform activity recognition comprises estimating characteristics of each movement vector in the plurality of movement vectors.

6. The method of claim 5, wherein characterizing the extracted features to perform activity recognition further comprises comparing the respective characteristics of each movement vector in the plurality of movement vectors to characteristics of at least one predetermined vector.

7. The method of claim 1, wherein extracting features from the flow include producing parameters that describe a movement, and wherein characterizing the extracted features to perform activity recognition comprises determining whether, the parameters describing the movement are within a threshold to a predetermined motion model.

8. The method of claim 1, wherein characterizing the extracted features to perform activity recognition comprises performing simple-activity recognition.

9. The method of claim 1, wherein characterizing the extracted features to perform activity recognition comprises performing complex-activity recognition.

10. The method of claim 9, wherein performing complex-activity detection comprises determining whether a predetermined number of simple activities have been detected.

11. The method of claim 10, wherein determining whether a predetermined number of simple activities have been detected comprises using a graphical model.

12. A method of using motion textures to detect abnormal activity, the method comprising:
selecting a first plurality of frames from a first video sequence;
analyzing motion textures in the first plurality of frames to identify a first flow, wherein the first flow defines a first temporal and first spatial segmentation of respective regions in the first plurality of frames, and wherein the regions show a first consistent pattern of motion;
extracting first features from the first flow;
comparing the first features with second features extracted during a previous training phase; and
based on the comparison, determining whether the first features indicate abnormal activity.

13. The method of claim 12, wherein the training phase comprises:
selecting a second plurality of frames from a second video sequence;
analyzing motion textures in the second plurality of frames to identify a second flow, wherein the second flow defines a second temporal and second spatial segmentation of respective regions in the second plurality of frames, and wherein the regions show a second consistent pattern of motion; and
extracting second features from the second flow.

14. The method of claim 12, wherein determining whether the first features indicate abnormal activity comprises determining if a similarity measure between the first and second features exceeds a predetermined threshold.

15. The method of claim 13, wherein extracting features from the first flow comprises forming a first motion-texture model, wherein extracting features from the second features comprises forming a second motion-texture model, wherein comparing the first features with second features comprises comparing the first and second motion-texture models.

16. The method of claim 15, wherein determining whether the first features indicate abnormal activity comprises determining if a similarity measure between the first and second motion-texture models exceeds a predetermined threshold.

17. A method of segmenting regions in a video sequence that display consistent patterns of activities, the method comprising:
a. partitioning a given frame into a plurality of patches;
b. forming a vector model for each patch by analyzing motion textures associated with that patch; and
c. clustering patches having vector models that show a consistent pattern.

18. The method of claim 17, wherein the given frame is part of a plurality of frames in a video sequence, the method further comprising repeating steps a-c for each frame in the plurality of frames.

19. The method of claim 17, wherein clustering patches having vector models that show a consistent pattern comprises clustering patches that include vector models that are concentric around a given patch.

20. The method of claim 17, wherein each patch in the plurality of patches is adjacent to neighboring patches, and wherein forming a vector model for each patch by analyzing motion textures associated with that patch comprises:
estimating motion-texture parameters for each patch in the plurality of patches;
for each given patch in the plurality of patches and for each neighboring patch to the given patch, calculating a motion-texture distance between the motion-texture parameters of the given patch and the motion-texture parameters of the neighboring patch; and
based on the motion-texture distance calculations for each patch in the plurality of patches, forming a vector model for each patch in the plurality of patches.
